(19) United States
(12) Patent Application Publication
(10) Pub. No.: US 2020/0129369 A1
(43) Pub. Date: Apr. 30, 2020

(54) MASSAGE TOOL

(71) Applicants: Georgina Sarah Pearce, BYRON (AU); Gemma Louise Pearce, BYRON (AU)

(72) Inventors: Georgina Sarah Pearce, BYRON (AU); Gemma Louise Pearce, BYRON (AU)

(21) Appl. No.: 16/668,018

(22) Filed: Oct. 30, 2019

Related U.S. Application Data
(60) Provisional application No. 62/752,463, filed on Oct. 30, 2018.

(51) Int. Cl. A61H 7/00

(52) U.S. Cl. CPC A61H 7/003

(57) ABSTRACT

A therapeutic manual massage tool for efficiently inducing the body's natural healing responses during therapeutic massage therapy. The manual massage tool has a substantially flat base from which a plurality of protrusions are radially disposed about the base. The plurality of protrusions are arranged in coaxially aligned circumferential rings about a central protrusion, such as in a Lotus flower shape. The protrusions are generally petal shaped and may terminate with a generally cylindrical or spheroidal tip.

### BACKGROUND OF THE INVENTION

The present invention relates to the art of massage, and more particularly to tools for manual massage therapy.

Massage is a time honored method of relieving sore muscles from activity. It is also practiced for its therapeutic effects in enhancing relaxation, which may benefit those suffering from insomnia, certain headaches, anxiety, and other conditions.

While there are currently a number of massage tools available, these tools lack a sufficient number of spikes or protrusions with the desired shape to interact with a person's tissues to promote a natural healing response in the body more efficiently.

As can be seen, there is a need for improved massage tool that efficiently promotes natural healing responses.

### BRIEF DESCRIPTION OF THE DRAWINGS

FIG. 1 is a rendering of a top perspective view of an embodiment of a tissue massage tool;

FIG. 2 is a side elevation view thereof;

FIG. 3 is a top plan view thereof;

FIG. 4 is a bottom plan view thereof;

FIG. 5 is a top right perspective view thereof;

FIG. 6 is a top left perspective view thereof;

FIG. 7 is a top front perspective view thereof;

FIG. 8 is a top perspective view of an embodiment of a tissue massage tool;

FIG. 9 is a side elevation view thereof;

FIG. 10 is a top plan view thereof;

FIG. 11 is a bottom plan view thereof;

FIG. 12 is a top right perspective view thereof; and

FIG. 13 is top left perspective view thereof.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, embodiments of the present invention provides a manual massage tool having a plurality (generally twenty five) of protrusions, terminating in a spike, to efficiently promote the body's natural healing responses during self-led therapeutic manual massage. The therapeutic manual massage tool may be employed for relief of muscle soreness from activity. The therapeutic manual massage tool may also be employed for relaxation and stress leading to insomnia, certain headaches, anxiety. With the manual massage tool of the present invention, the enhanced benefits of a self-led manual massage therapy session can improve quality of sleep, stimulate the body's release of endorphins and improve mood, and eliminate stress from the body.

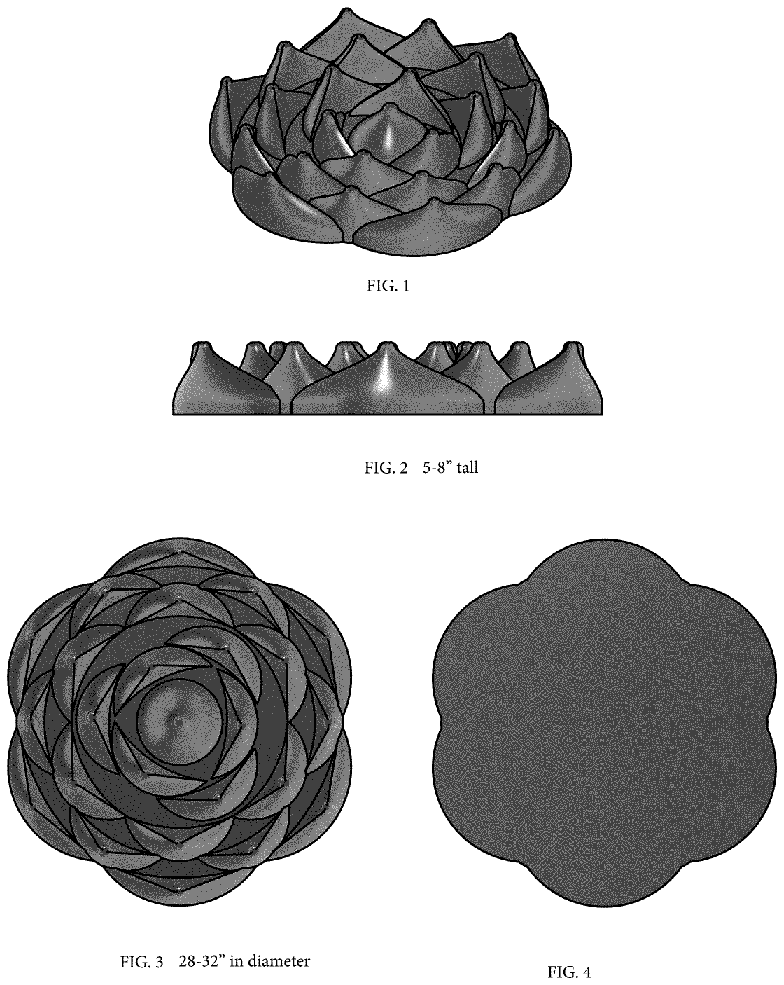

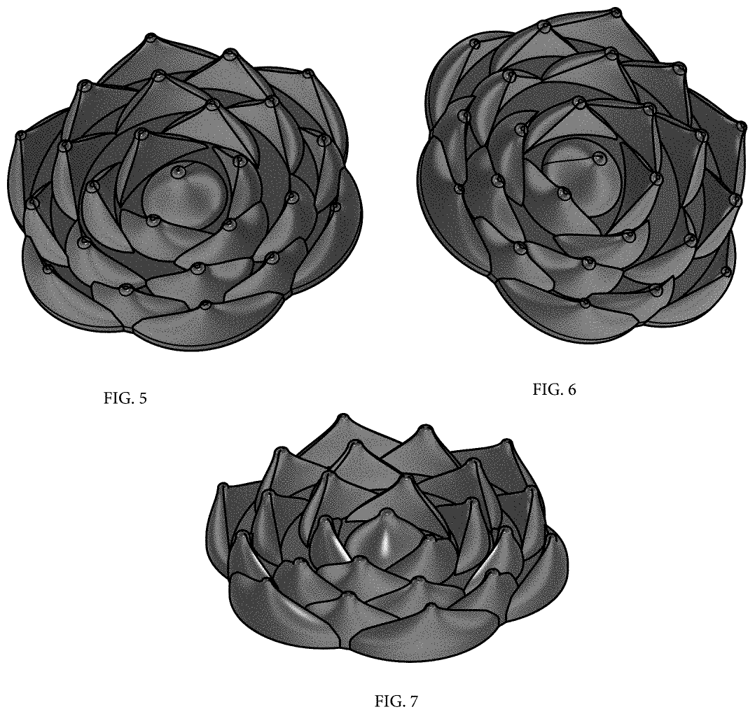

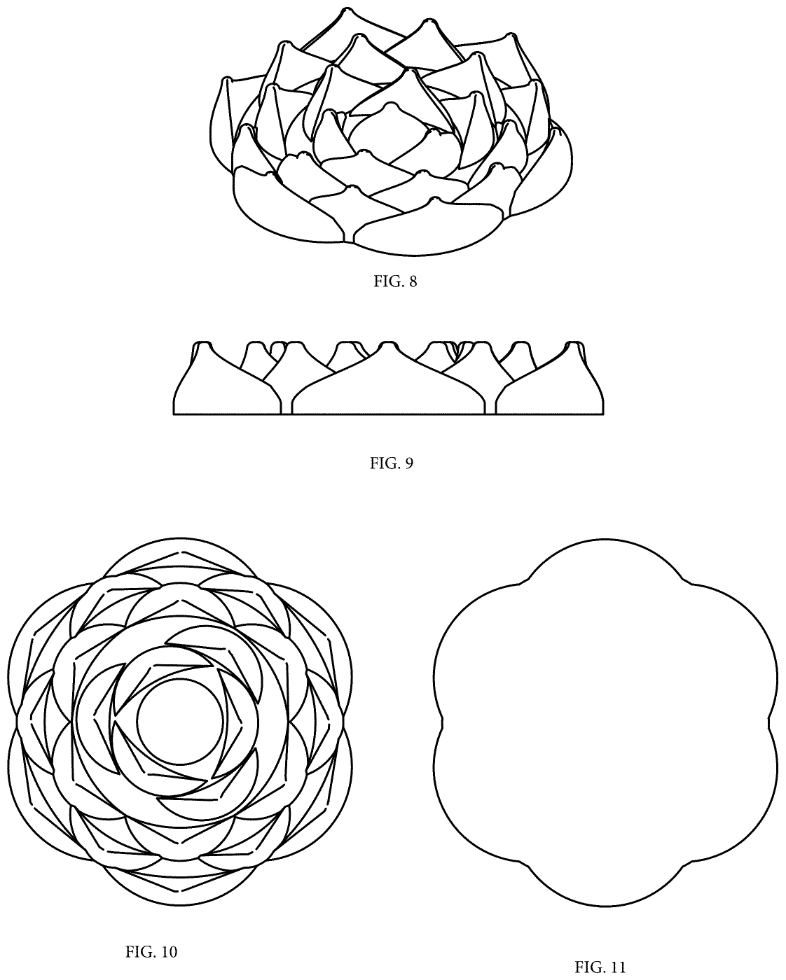

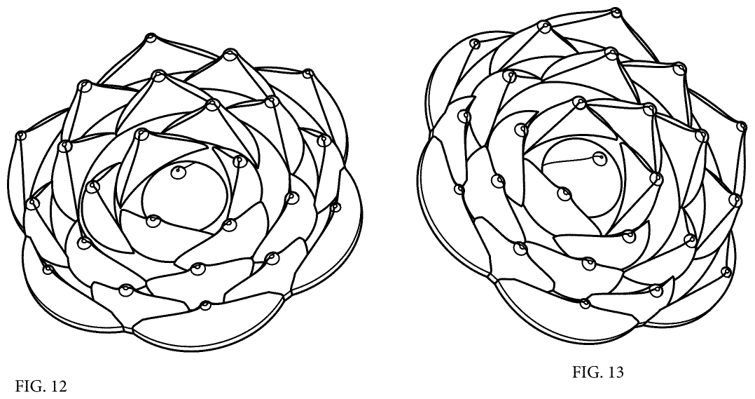

As seen in reference to the drawings of FIGS. 1-13, a manual massage tool of the present invention has a substantially flat base from which a plurality of protrusions radially disposed about the base. The plurality of protrusions are arranged in coaxially aligned circumferential rings about a central protrusion, such as in a Lotus flower. Preferably, at least three protrusions are provided on each of the circumferential rings, with the protrusions of adjacent rings offset such that the tip of one ring is positioned between the tips of the inner or outer adjacent ring protrusions. The protrusions are generally petal shaped and may terminate with a generally cylindrical or spheroidal tip. The spheroidal tip may also include a spiked point protrusion.

The manual massage tool may be formed from a molded plastic, a composite, ceramic, or metallic material. Preferably, the material will be light weight, such as plastic, to make it easy to manipulate by the user undergoing the therapeutic manual massage without inducing fatigue.

The self-led therapeutic manual massage may also be employed for relaxation and stress leading to insomnia, certain headaches, anxiety. With the massage tool of the present invention, the enhanced benefits of a self-led manual massage therapy session can improve quality of sleep, stimulate the body's release of endorphins and improve mood, and eliminate stress from the body.

It should be understood, of course, that the foregoing relates to exemplary embodiments of the invention and that modifications may be made without departing from the spirit and scope of the invention as set forth in the following claims.

What is claimed is:

1. A therapeutic manual massage tool as shown and described.
